(19) United States
(12) Patent Application Publication
(10) Pub. No.: US 2015/0326382 A1
(43) Pub. Date: Nov. 12, 2015

(54) INITIALIZATION OF TIMING RECOVERY AND DECISION-FEEDBACK EQUALIZATION IN A RECEIVER

(71) Applicants: Jian LI, (US); Yisheng XUE, (US); Michael M. FAN, (US); Jilei HOU, (US); Yin Huang, San Diego, CA (US); Fuyun Ling, San Diego, CA (US); QUALCOMM INCORPORATED, San Diego, CA (US)

(72) Inventors: Jian Li, Beijing (CN); Yin Huang, Beijing (CN); Yisheng Xue, San Diego, CA (US); Michael M. Fan, San Diego, CA (US); Fuyun Ling, San Diego, CA (US); Jilei Hou, San Diego, CA (US)

(21) Appl. No.: 14/763,798

(22) PCT Filed: Jan. 28, 2013
(86) PCT No.: PCT/CN2013/071035

§ 371 Date: Jul. 27, 2015

(51) Int. Cl. H04L 7/00; H04L 25/03

(52) U.S. Cl. CPC H04L 7/0004; H04L 25/0307; H04L 25/0305; H04L 2025/03656

(57) ABSTRACT

A method of initializing a receiver is performed during an initialization mode. Timing offset values for a timing recovery circuit are repeatedly selected. For each selected timing offset value, timing recovery is performed using the timing offset value and groups of weights for a decision feedback equalizer are repeatedly selected. Each selected group of weights is used to perform blind decision feedback equalization. For each selected group of weights, a metric indicating data reception quality is computed. A timing offset value and a group of weights are chosen based on the computed metrics.

### TECHNICAL FIELD

The present embodiments relate generally to receivers in communication systems, and specifically to receivers that perform timing recovery and decision-feedback equalization.

### BACKGROUND OF RELATED ART

Dispersion in a communication channel causes inter-symbol interference. For example, multimode optical fibers as used in local area network (LAN) applications suffer from dispersion. The amount of inter-symbol interference increases with the length of the fiber. Electronic dispersion compensation (EDC) may be performed to compensate for this interference.

EDC may be implemented using a decision feedback equalizer (DFE) in the receiver of a modem. One example of a DFE is a blind DFE, which is also referred to as a decision-direct DFE and which may be implemented digitally. Such a DFE is considered to be blind because it does not use a training sequence to converge on values for weights that it uses to determine its feedback. A receiver with a blind DFE may also include a timing recovery circuit to determine a timing offset value for the receiver. While a receiver with a digital blind DFE and a timing recovery circuit may provide a low bit error rate (BER), designing such a receiver to converge on its DFE weighting and timing offset values within a reasonable period of time presents significant challenges.

### BRIEF DESCRIPTION OF THE DRAWINGS

The present embodiments are illustrated by way of example and are not intended to be limited by the figures of the accompanying drawings.

FIG. 1 is a block diagram of a receiver in a modem in accordance with some embodiments.

FIG. 2 is a circuit diagram showing a portion of circuitry in a DFE in accordance with some embodiments.

FIG. 3 is a circuit diagram showing circuitry in a timing recovery circuit in accordance with some embodiments.

FIGS. 4A and 4B are flowcharts illustrating methods of selecting initial timing offset and DFE weighting values for use during a normal mode of operation in accordance with some embodiments.

FIG. 4C is a flowchart illustrating a method of operating a receiver in a normal mode of operation in accordance with some embodiments.

FIG. 5A is a flowchart showing a method of initializing a receiver in accordance with some embodiments.

FIG. 5B is a flowchart showing a method of operating a receiver in accordance with some embodiments.

FIG. 6 is a block diagram of a modem that includes a processor in accordance with some embodiments.

Like reference numerals refer to corresponding parts throughout the drawings and specification.

### DETAILED DESCRIPTION

Embodiments are disclosed in which an initial timing offset value for a timing recovery circuit and groups of initial weights for a decision feedback equalizer (DFE) are chosen during an initialization mode for a receiver.

In some embodiments, a method of initializing a receiver is performed during an initialization mode. Timing offset values for a timing recovery circuit are repeatedly selected. For each selected timing offset value, timing recovery is performed using the timing offset value. Also, for each selected timing offset value, groups of weights for a decision feedback equalizer are repeatedly selected. Each selected group of weights is used to perform blind decision feedback equalization. For each selected group of weights, a metric indicating data reception quality is computed. A timing offset value and a group of weights are chosen based on the computed metrics.

In some embodiments, a receiver includes an analog-to-digital converter (ADC) to sample a received signal, a DFE to equalize the sampled signal, and a timing recovery circuit to provide a timing offset to the ADC. The receiver also includes a controller to select between an initialization mode of operation and a normal mode of operation. In the initialization mode the controller is to repeatedly select timing offset values for the timing recovery circuit in a first loop and to repeatedly select groups of weights for the DFE in a second loop nested within the first loop.

In some embodiments, a non-transitory computer-readable storage medium stores instructions that, when executed by a processor in a modem during an initialization mode, cause the modem to repeatedly select timing offset values for a timing recovery circuit. For each selected timing offset value, the instructions cause the modem to perform timing recovery using the timing offset value, repeatedly select groups of weights for a DFE, use each selected group of weights to perform blind decision feedback equalization, and compute a metric indicating data reception quality for each selected group of weights. The instructions also cause the modem to choose a timing offset value and group of weights based on the computed metrics.

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

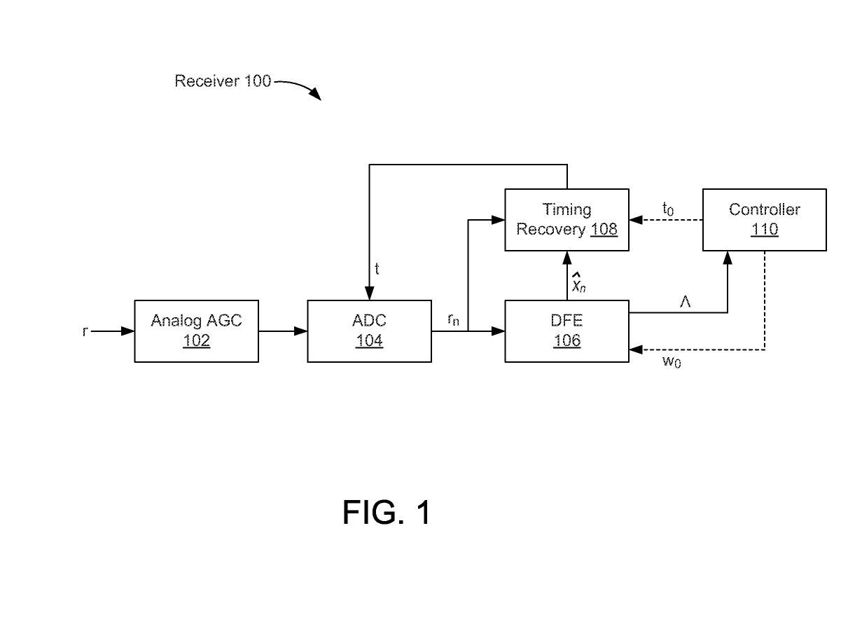

FIG. 1 is a block diagram of a receiver 100 in a modem in accordance with some embodiments. In some embodiments, the receiver 100 is a 10 Gbps long-reach multi-mode fiber Ethernet (10GBase-LRM) receiver. A received analog signal r is amplified by an analog automatic gain control (AGC) amplifier 102 and then digitized by an analog-to-digital converter (ADC) 104, resulting in a digital signal rₙ, where n indexes respective samples of the digital signal rₙ as generated by the ADC 104. The digital signal rₙ is provided to a DFE 106 and a timing recovery circuit 108. In some embodiments, the DFE 106 is a blind digital DFE that performs electronic dispersion compensation (EDC) without receiving a training sequence. The result of the EDC performed by the DFE 106 is a signal \hat{x}ₙ, which the DFE 106 provides to the timing recovery circuit 108. In addition to performing EDC, the DFE 106 calculates a metric Λ indicating data reception quality and provides the metric Λ as an output to a controller 110. The controller 110 provides an initial timing offset t₀ to the timing recovery circuit 108. Based on the digital signals rₙ and \hat{x}ₙ and the initial timing offset t₀, the timing recovery circuit 108 tunes a timing offset t and provides the tuned timing offset t to the ADC 104, which samples the signal r in accordance with the tuned timing offset t. The controller 110 also provides a group of initial weights w₀ to the DFE 106, which uses the group of initial weights w₀ to perform blind decision feedback equalization and thus to perform EDC.

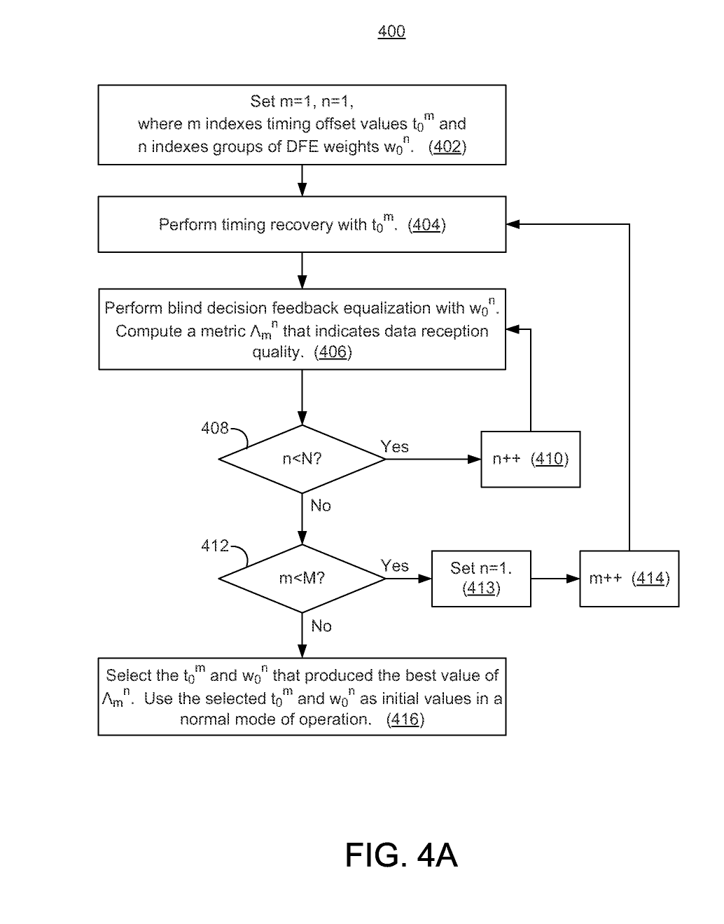

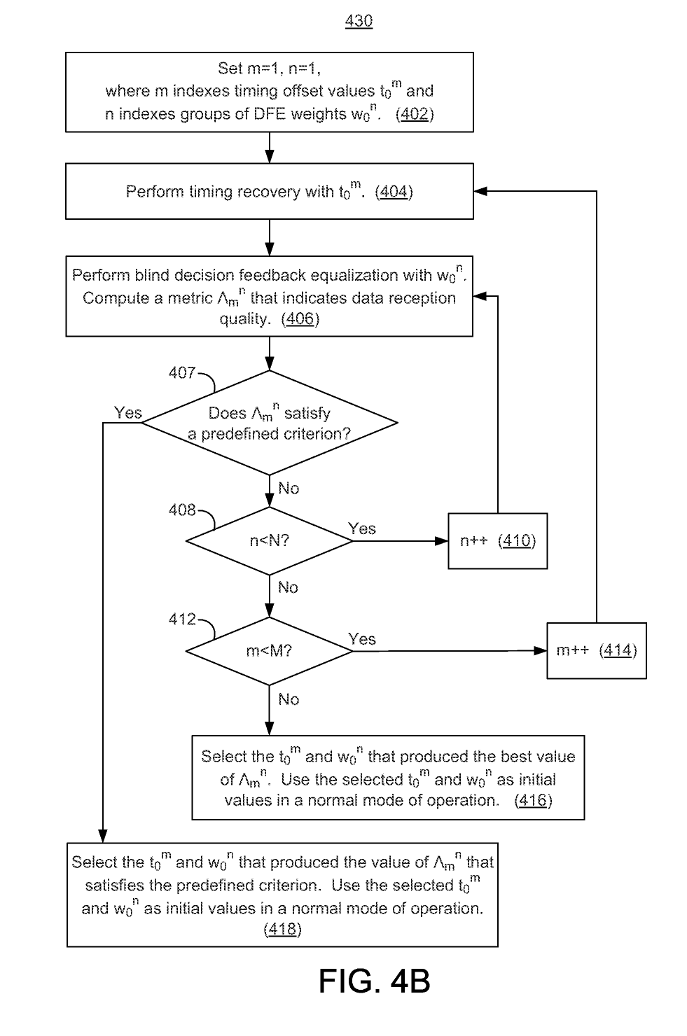

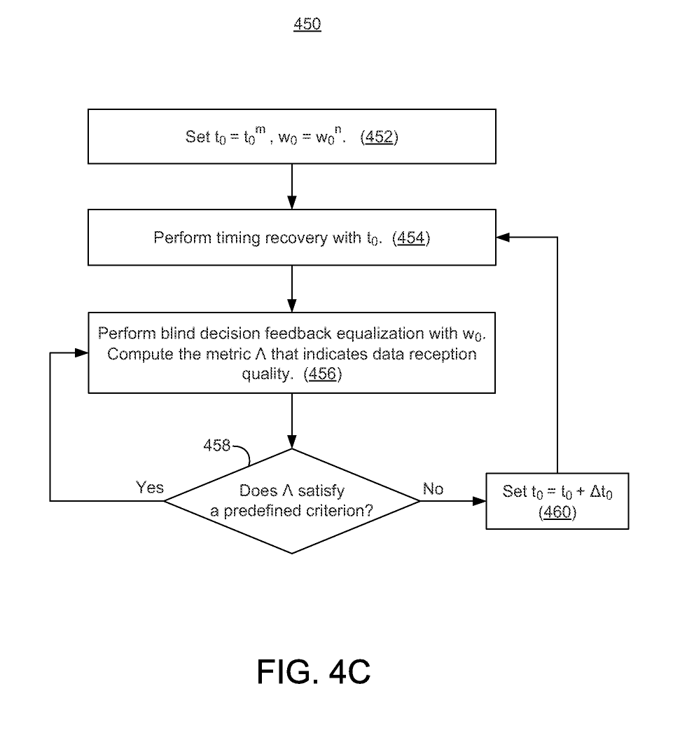

In addition, the controller 110 selects between an initialization mode of operation and a normal mode of operation for the receiver 100. In the initialization mode, the controller 110 repeatedly selects timing offset values for the timing recovery circuit 108 from a candidate set of timing offset values and repeatedly selects groups of weights for the DFE 106 from a candidate set of groups of weights. In some embodiments, timing offset values are repeatedly selected from the candidate set of timing offset values in a first loop and groups of weights are repeatedly selected from the candidate set of groups of weights in a second loop nested within the first loop, as described below with respect to FIGS. 4A and 4B. The selected timing offset values and groups of weights are evaluated by using them to perform: timing recovery in the timing recovery circuit 108, decision feedback equalization in the DFE 106, and computation of respective metrics Λ, which indicate data reception quality. The initial timing offset value t₀ the group of initial weights w₀ are chosen for use in the normal mode of operation, based on the computed metrics Λ. The controller 110 provides the chosen timing offset value t to the timing recovery circuit 108 and the chosen group of weights w₀ to the DFE 106.

In the normal mode of operation, the controller 110 may perform a search for a new timing offset value based on a determination that the metric Λ does not satisfy a predefined criterion, as described below with respect to FIG. 4C in accordance with some embodiments.

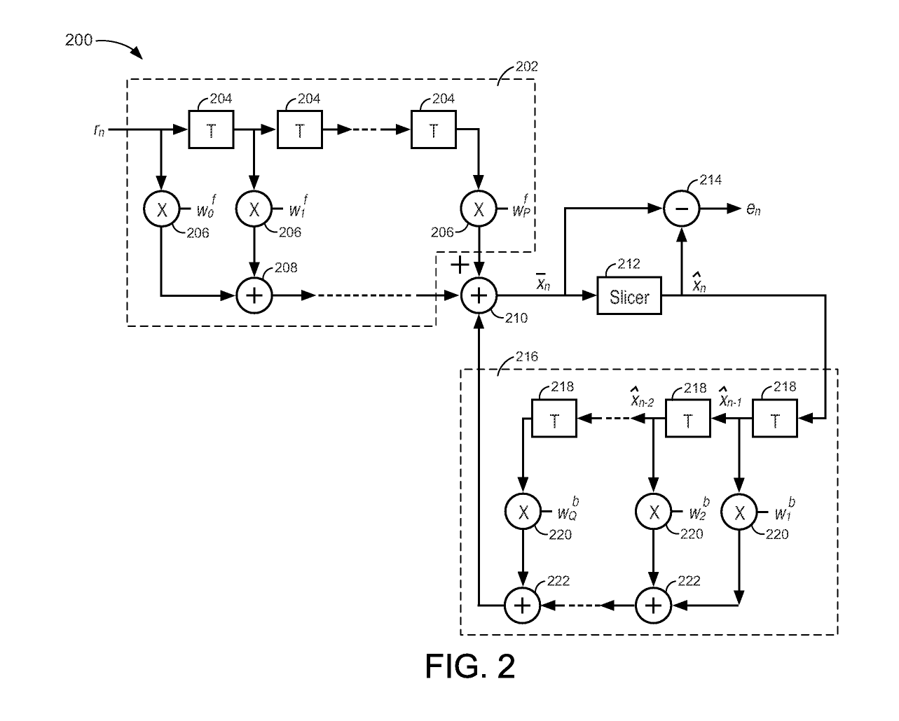

FIG. 2 is a circuit diagram showing circuitry 200 in the DFE 106 (FIG. 1) in accordance with some embodiments. The DFE 106 includes a first filter portion 202 that performs feed-forward equalization and a second filter portion 216 that performs feedback equalization. A combiner 210 combines the outputs of the first filter portion 202 and second filter portion 216 to generate a signal x̅ₙ and provides x̅ₙ to a slicer 212 to generate \hat{x}ₙ. In some embodiments, the slicer 212 is a two-level slicer, such that:

\hat{x}ₙ=sig n( x̅ₙ) (1)

A combiner 214 subtracts \hat{x}ₙ from x̅ₙ to generate an error signal eₙ:

eₙ= x̅ₙ−\hat{x}ₙ (2)

The first filter portion 202 receives the digital signal rₙ and provides it to a series of P baud-rate delay stages 204, where P is an integer greater than one. Each delay stage 204 introduces a delay of one symbol period. The output of each delay stage 204, and the input of the first delay stage 204, is provided to a respective mixer 206, where it is multiplied by a respective weight of a series of weights w₀^{f} through e_{P}^{f}. Each of the weights w₀^{f} through w_{P}^{f} is thus provided to a respective mixer 206, and P+1 successive samples of the digital signal rₙ are thus weighted by respective weights in the series of weights w₀^{f} through w_{P}^{f}. Combiners 208 combine the outputs of the mixers 206, such that the sum of the P successive weighted samples generated by the first filter portion 202 is provided to the combiner 210.

The second filter portion 216 receives the output \hat{x}ₙ of the slicer 212 and provides it to a series of Q baud-rate delay stages 218, where Q is an integer greater than one. Each delay stage 218 introduces a delay of one symbol period. The output of each delay stage 218 is provided to a respective mixer 220, where it is multiplied by a respective weight of a series of weights w₁^{b} through w_{Q}^{b} provided to the respective mixer 220, and Q successive samples of \hat{x}ₙ are thus weighted by respective weights in the series of weights w₁^{b} through w_{Q}^{b}. Combiners 222 combine the outputs of the mixers 220, such that the sum of the Q successive weighted samples generated by the second filter portion 216 is provided to the combiner 210.

The formula for the input x̅ₙ to the slicer 212 is thus:

x̅ₙ=Σᵢ₌₀^{P}wᵢ^{f}rₙ₋ᵢ−Σᵢ₌₁^{Q}wᵢ^{b}\hat{x}ₙ₋₁₋ᵢ (3)

The DFE 106 (FIG. 1) updates the weights used in the first filter portion 202 and second filter portion 216 based on the error signal eₙ. The weights in the first filter portion 202 are updated using the following formula:

wᵢ^{f}←wᵢ^{f}−μ_{f}eₙrₙ₋ᵢ (4)

Where i=0, 1 . . . , P and μᵣ is a predefined coefficient. The weights in the second filter portion 216 are updated using the following formula:

wᵢ^{b}←wᵢ^{b}−μ_{b}eₙ\hat{x}ₙ₋₁₋ᵢ (5)

Where i=1, . . . , Q and μ_{b} is a predefined coefficient.

The DFE 106 (FIG. 1) uses one or more of the values calculated by the circuitry 200 to compute the metric Λ. Examples of the metric Λ include but are not limited to the minimum distance (MD) between the DFE 106 output and the 0-1 decision threshold, the mean-square error (MSE), and the signal-to-noise ratio of the DFE 106 output (“post-SNR”), which are respectively computed as follows:

$$\begin{matrix}MD = min ( \vert {\overline{x}}_{n} \vert ) & ( 6 ) \\ MSE = {\sum }_{n} ( {\vert {e}_{n} \vert}^{2} ) & ( 7 ) \\ Post - SNR = 10 log 10 ( {\sum }_{n} \frac{1}{{e}_{n}^{2}} ) & ( 8 )\end{matrix}$$

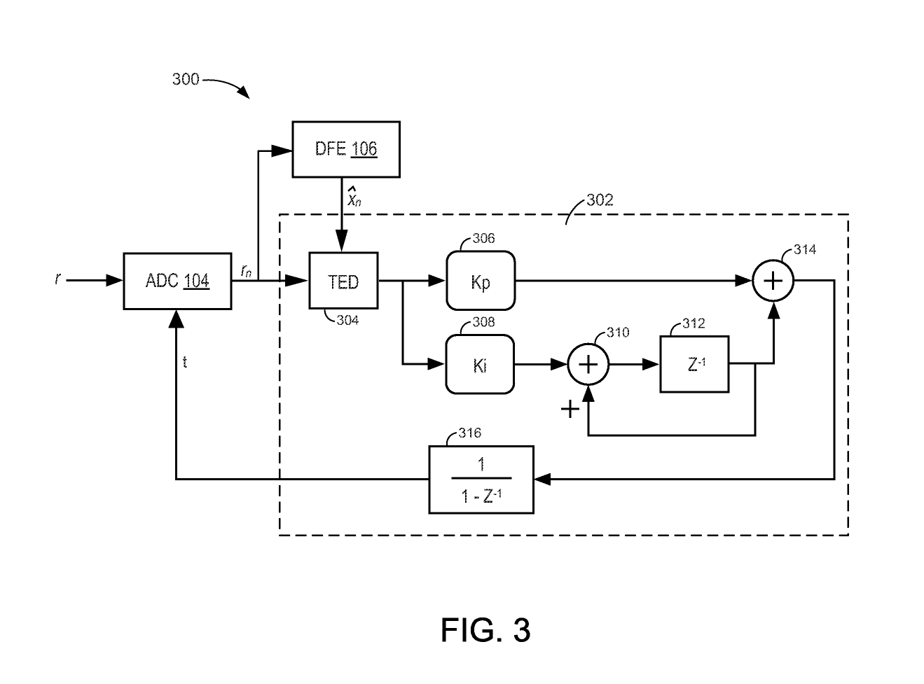

FIG. 3 is a circuit diagram 300 showing the ADC 104 and DFE 106 (FIG. 1) coupled to circuitry 302 in the timing recovery circuit 108 (FIG. 1) in accordance with some embodiments. The circuitry 302 provides a timing offset t to the ADC 104, which samples the signal r in accordance with the timing offset t, thereby producing the digital signal rₙ. (The initial timing offset t₀ that the controller 110, FIG. 1, provides to the timing recovery circuit 108 serves as initial value of t when performing timing recovery.) The digital signals rₙ and \hat{x}ₙ are respectively provided to a timing error detection (TED) block 304 by the ADC 104 and DFE 106. In some embodiments, the TED block 304 implements a Mueller-Muller algorithm. The output of the TED block 304 is provided to both proportional and integral weighting paths. In the proportional path, the output of the TED block 304 is weighted by a weight Kp 306. In the integral path, the output of the TED block 304 is weighted by a weight Ki 308 and integrated by an integrator that includes a combiner 310 and a delay stage 312. The output of the delay stage 312 is provided as an input to the combiner 310, thus integrating a current Ki-weighted sample of the output of the TED block 304 with a previous Ki-weighted sample of the output of the TED block 304. A combiner 314 combines the data on the proportional and integral weighting paths. The output of the combiner 314 is provided as the input of an integrator 316 (e.g., a second-order locked loop), which generates the timing offset t as its output.

The initial timing offset t₀, as provided from the controller 110 to the timing recovery circuit 108 (FIG. 1), and the initial DFE weights w₀, as provided from the controller 110 to the DFE 106 (FIG. 1), affect how long it takes the values of the timing offset and DFE weights to converge. (In the example of FIG. 2, w₀ refers to the full set of DFE weights w₀^{f} through w_{P}^{f} and w₁^{b} through w_{Q}^{b}.) Accordingly, it may be desirable to choose initial values that result in short convergence times (e.g., that reduce or minimize the convergence times). In some embodiments, these initial values are determined during the initialization mode.

FIG. 4A is a flowchart illustrating a method 400 of selecting initial timing offset and DFE weighting values for use during a normal mode of operation in accordance with some embodiments. The method 400 may be performed by the receiver 100 (FIG. 1) during the initialization mode, before entering the normal mode of operation. In some embodiments, the method 400 is performed under the control of the controller 110 (FIG. 1).

In the method 400, a candidate set of initial timing offset values tₒ^{m} is available, where m=1, 2, . . . , M and M is an integer greater than one. Also, a candidate set of groups of initial DFE weights wₒⁿ (e.g., blind DFE weights) is available, where n=1, 2, . . . , N and N is an integer greater than one. Each candidate group of weights wₒⁿ includes a full set of weights for the DFE 106 (e.g., DFE weights w₀^{f} through and w_{P}^{f} through w_{Q}^{b}, FIG. 2). The variable m thus indexes the timing offset values tₒ^{m} and the variable n thus indexes the groups of weights wₒⁿ.

The method 400 loops through each combination of m and n in a nested loop, with m being incremented in an outer loop and n being incremented in an inner loop. Before entering the nested loop, the variables m and n are set (402) equal to one.

The method 400 then enters the outer loop. In each pass of the outer loop, a different initial timing offset value tₒ^{m} is selected (e.g., tₒ¹ is selected in the first pass of the outer loop). Timing recovery is performed (404) in the timing recovery circuit 108 (FIG. 1) using the selected initial timing offset value tₒ^{m}.

When the timing recovery circuit 108 (FIG. 1) is convergent, the method enters the inner loop. For each value of n, a corresponding group of blind DFE weights wₒⁿ is selected (e.g., wₒ¹ is selected in the first pass of the inner loop). Blind decision feedback equalization is performed (406) using the selected group of DFE weights wₒⁿ as initial weighting values in the DFE 106. When the DFE 106 is convergent, a metric Λₘⁿ is computed (406). Examples of the metric Λₘⁿ include MD (e.g., as defined in equation 6), MSE (e.g., as defined in equation 7), and Post-SNR (e.g., as defined in equation 8).

A determination is made (408) as to whether n is less than N. If n is less than N (408-Yes), the value of n is incremented (410) by one (n++) and blind decision feedback equalization is performed (406) again, with a corresponding value of the metric Λₘⁿ being computed. Execution of the method 400 thus remains in the inner loop.

If n is not less than N (408—No), however, then execution of the inner loop ends. A determination is then made (412) as to whether m is less than M. If m is less than M (412—Yes), the value of n is reset (413) to one and the value of m is incremented (414) by one (m++). Timing recovery is performed (404) in the timing recovery circuit 108 (FIG. 1) using the selected initial timing offset value t₀^{m}. The method 400 then re-enters the inner loop of operations 406, 408, and 410.

If m is not less than M (412—No), however, then the outer loop is complete and the metric Λₘⁿ has been computed for each combination of n and m. The best value of the metric Λₘⁿ is determined and the corresponding timing offset value t₀^{m} and group of blind DFE weights w₀ⁿ that produced the best value of the metric Λₘⁿ are selected (416) for use as initial values during the normal mode of operation. For MD (e.g., as defined in equation 6) and post-SNR (e.g., as defined in equation 8), the best value of the metric Λₘⁿ is the largest value. For MSE (e.g., as defined in equation 7), the best value of the metric Λₘⁿ is the lowest value.

FIG. 4B illustrates an alternate method 430 of selecting the initial timing offset and initial DFE weights for use during the normal mode of operation. The method 430, like the method 400 (FIG. 4A), may be performed by the receiver 100 (FIG. 1) during the initialization mode, before entering the normal mode of operation.

The method 430 is performed in the same manner as the method 400 (FIG. 4A), except that after performing (406) the blind decision feedback equalization and computing (406) the metric Λₘⁿ, the metric Λₘⁿ is tested (407) to determine whether it satisfies a predefined criterion. If MD (e.g., as defined in equation 6) or post-SNR (e.g., as defined in equation 8) is used as the metric Λₘⁿ, the predefined criterion is satisfied if the metric Λₘⁿ is greater than (or in some embodiments greater than or equal to) a predefined threshold. If MSE (e.g., as defined in equation 7) is used as the metric Λₘⁿ, the predefined criterion is satisfied if the metric Λₘⁿ is less than (or in some embodiments less than or equal to) a predefined threshold. If the criterion is satisfied, the nested looping stops, such that the repeated selection and testing of respective timing offset values t₀^{m} and groups of DFE weights wₒⁿ ceases. The timing offset value tₒ^{m} and group of DFE weights wₒⁿ that produced the value of the metric Λₘⁿ that satisfied the criterion are selected (418) for use as initial values during the normal mode of operation.

FIG. 4C is a flowchart illustrating a method 450 of operating the receiver 100 (FIG. 1) in the normal mode of operation in accordance with some embodiments. An initial timing offset t₀ is set (452) equal to tₒ^{m}, as selected during the operation 416 or 418 of the method 400 or 430 (FIGS. 4A-4B). A group of initial DFE weights w₀ is set (452) equal to wₒⁿ, as selected during the operation 416 or 418 of the method 400 or 430 (FIGS. 4A-4B).

Timing recovery is performed (454) in the timing recovery circuit 108 (FIG. 1) using the initial timing offset t₀.

When the timing recovery circuit 108 (FIG. 1) is convergent, blind decision feedback equalization is performed (456) using the group of initial DFE weights w₀. When the DFE 106 is convergent, the metric Λ is computed (456). The metric Λ is compared (458) to a predefined criterion. This comparison is performed, for example, by the controller 110 (FIG. 1). If the metric Λ satisfies the criterion (458-Yes), the DFE continues to perform (456) blind decision feedback equalization and compute the metric Λ, which is repeatedly compared (458) to the criterion. If MD (e.g., as defined in equation 6) or post-SNR (e.g., as defined in equation 8) is used as the metric Λ, the predefined criterion is satisfied if the metric Λ is greater than (or greater than or equal to) a predefined threshold. If MSE (e.g., as defined in equation 7) is used as the metric Λ, the predefined criterion is satisfied if the metric Λ is less than (or less than or equal to) a predefined threshold.

If, however, the metric Λ does not satisfy the criterion (458—No), then the controller 110 (FIG. 1) increments the initial timing offset t₀ by an amount Δt₀ (i.e., t₀=t₀+Δt₀) and provides the incremented timing offset t₀ to the timing recovery circuit 108 (FIG. 1). The value Δt₀ may be either positive or negative. The timing recovery circuit 108 (FIG. 1) performs (454) timing recovery using the incremented timing offset t₀. Once the timing recovery circuit 108 (FIG. 1) is convergent, the DFE 106 performs (456) decision feedback equalization and computes (456) the metric Λ, which is compared (458) to the predefined criterion. If the metric Λ still does not satisfy the criterion (458—No), the timing offset t₀ is again incremented (460) and timing recovery is again performed (454); this loop repeats until a timing offset t₀ is found that results in a metric Λ that satisfies (458—Yes) the criterion. In some embodiments, repeated incrementing of the timing offset t₀ is done in a manner such that a bi-directional search centred on the initial timing offset t₀ is performed.

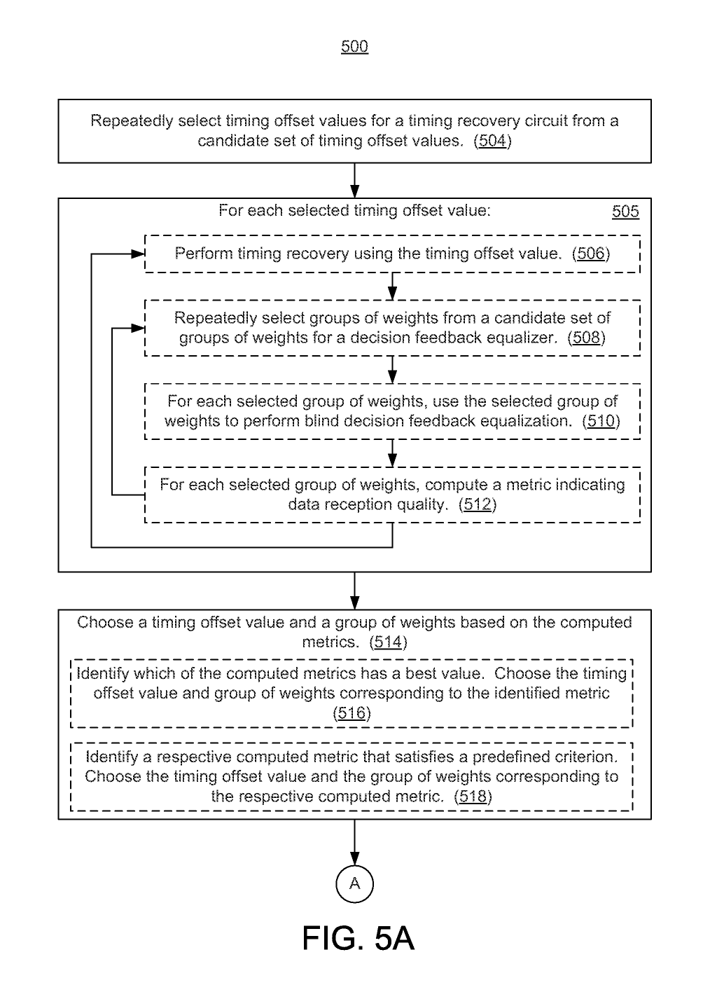

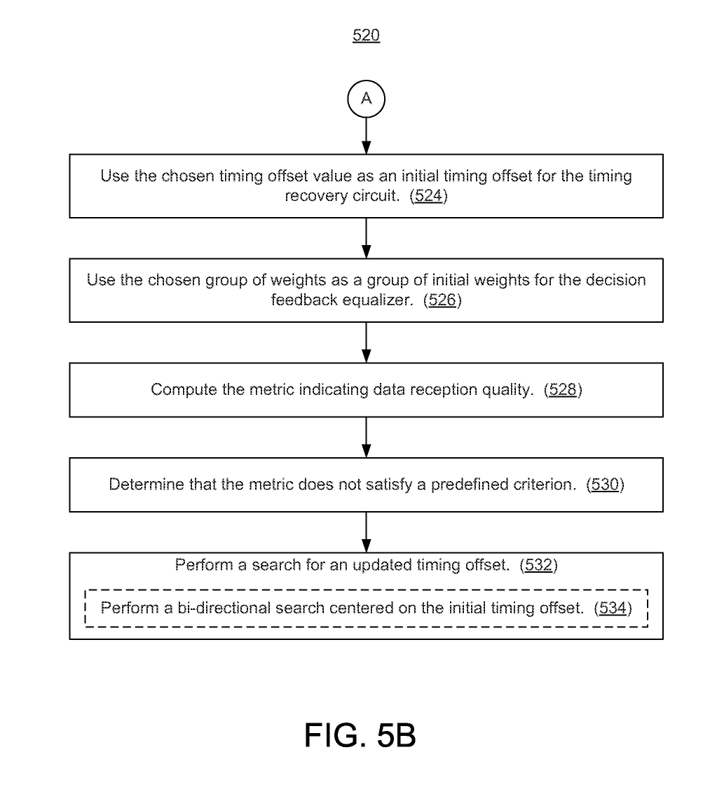

FIG. 5A is a flowchart showing a method 500 of initializing a receiver 100 (FIG. 1) in accordance with some embodiments. The method 500 is performed by the receiver 100 during an initialization mode.

Timing offset values t₀ for a timing recovery circuit 108 (FIG. 1) are repeatedly selected (504) from a candidate set of timing offset values. In some embodiments, the controller 110 (FIG. 1) selects the timing offset values t₀. For example, successive timing offset values t₀^{m} are selected as described in the methods 400 and 430 (FIGS. 4A-4B).

For each selected timing offset value t₀ (e.g., for each timing offset value t₀^{m}), multiple operations are performed (505). Timing recovery is performed (506) using the timing offset value (e.g., described for operation 404 of the methods 400 and 430, FIGS. 4A-4B). Groups of weights w₀ are repeatedly selected (508) from a candidate set of groups of weights for the DFE 106 (FIG. 1). In some embodiments, the controller 110 (FIG. 1) selects the groups of weights w₀. For example, successive groups of weights wₒⁿ are selected as described in the methods 400 and 430 (FIGS. 4A-4B). The DFE 106 (FIG. 1) uses each selected group of weights w₀ to perform (510) decision feedback equalization (e.g., as described for operation 406, FIGS. 4A-4B). Also, for each selected group of weights w₀, a metric Λ indicating data reception quality is computed (512) (e.g., as described for operation 406, FIGS. 4A-4B). For example, the DFE 106 (FIG. 1) computes the metric Λ.

A timing offset value t₀ and groups of weights w₀ are chosen (514) based on the computed metrics (e.g., as described for operation 416 or 418, FIGS. 4A-4B). In some embodiments, the timing offset value tₒ and groups of weights w₀ are chosen by the controller 110 (FIG. 1).

In some embodiments, the computed metric Λₘⁿ that has the best value is identified (516), and the timing offset value tₒ^{m} and group of DFE weights wₒⁿ corresponding to the identified metric Λₘⁿ are chosen (e.g., as described for operation 416, FIG. 4B). If MD (e.g., as defined in equation 6) or post-SNR (e.g., as defined in equation 8) is used for the metrics Λₘⁿ, the metric Λₘⁿ having the largest value is identified and the corresponding timing offset value tₒ^{m} and group of DFE weights wₒⁿ are chosen. If MSE (e.g., as defined in equation 7) is used for the metrics Λₘⁿ, the metric Λₘⁿ having the smallest value is identified and the corresponding timing offset value t₀^{m} and group of DFE weights wₒⁿ are chosen.

In some embodiments, a respective computed metric Λₘⁿ that satisfies a predefined criterion is identified (518) and the timing offset value tₒ^{m} and group of DFE weights wₒⁿ corresponding to the identified respective computed metric Λₘⁿ is chosen (e.g., as described for operation 418, FIG. 4B). If MD (e.g., as defined in equation 6) or post-SNR (e.g., as defined in equation 8) is used for the metrics Λₘⁿ, the predefined criterion is satisfied if a respective metric Λₘⁿ, is greater than (or in some embodiments greater than or equal to) a predefined threshold, in which case the corresponding timing offset value tₒ^{m} and group of DFE weights wₒⁿ are chosen. If MSE (e.g., as defined in equation 7) is used for the metrics Λₘⁿ, the predefined criterion is satisfied if a respective metric Λₘⁿ is less than (or in some embodiments less than or equal to) a predefined threshold, in which case the corresponding timing offset value tₒ^{m} and group of DFE weights wₒⁿ are chosen. Repeated selection of timing offset values t₀^{m} (504) and groups of DFE weights wₒⁿ (508) ceases in response to identifying the respective computed metric Λₘⁿ that satisfies the predefined criterion.

FIG. 5B is a flowchart showing a method 520 of operating a receiver 100 (FIG. 1) in accordance with some embodiments. The method 520 is performed by the receiver 100 during a normal mode of operation. In some embodiments, the method 520 is a continuation of the method 500 (FIG. 5A).

The timing offset value t₀ chosen in operation 514 (FIG. 5A) is used (524) as an initial timing offset for the timing recovery circuit 108 (FIG. 1). For example, the chosen timing offset value t₀ is used as described for the operation 454 of the method 450 (FIG. 4C).

The group of weights w₀ chosen in operation 514 (FIG. 5A) is used (526) as a group of initial weights for the decision feedback equalizer 106 (FIG. 1). For example, the chosen group of weights w₀ is used as described for the operation 456 of the method 450 (FIG. 4C).

The metric Λ indicating data reception quality is computed (528). For example, the metric Λ is computed as described for the operation 456 of the method 450 (FIG. 4C).

A determination is made (530) that the metric Λ does not satisfy a predefined criterion. In response, a search is performed (532) for an updated timing offset. For example, a search is performed in accordance with the loop that includes operations 458, 460, 454, and 456 in the method 450 (FIG. 4C). In some embodiments, a bi-directional search centered on the initial timing offset t₀ is performed (534).

While the methods 400, 430, 450, 500, and 520 (FIGS. 4A-4C, 5A-5B) include a number of operations that appear to occur in a specific order, it should be apparent that these methods can include more or fewer operations, some which can be executed serially or in parallel. An order of two or more operations may be changed, performance of two or more operations may overlap, and two or more operations may be combined into a single operation.

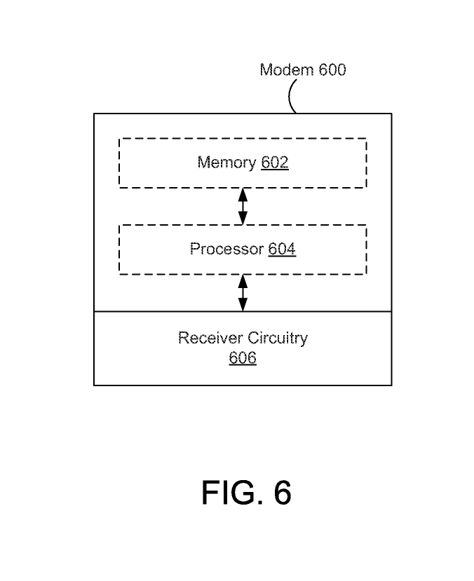

In some embodiments, the functionality of the controller 110 (FIG. 1) may be implemented in software. FIG. 6 is a block diagram of a modem 600 in which the controller 110 is implemented using a processor 604, in accordance with some embodiments. The processor is coupled to receiver circuitry 606, which includes the analog AGC amplifier 102, ADC 104, DFE 106, and timing recovery circuit 108 (FIG. 1). The processor 604 is also coupled to memory 602, which includes a non-transitory computer-readable storage medium (e.g., one or more nonvolatile memory elements, such as EPROM, EEPROM, Flash memory, a hard disk drive, and so on) that stores instructions for execution by the processor 604. In some embodiments, the instructions stored on the non-transitory computer-readable storage medium include instructions that, when executed by the processor 604, cause the modem 600 to perform all or a portion of the methods 400, 430, 450, 500, and/or 520 (FIGS. 4A-4C, 5A-5B).

While the memory 602 is shown as being separate from the processor 604, all or a portion of the memory 602 may be embedded in the processor 604. In some embodiments, the processor 604 and memory 602 are implemented in a single integrated circuit, which may or may not also include the receiver circuitry 606.

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A method of initializing a receiver, the method comprising:
during an initialization mode, repeatedly selecting timing offset values for a timing recovery circuit;
for each selected timing offset value:
performing timing recovery using the timing offset value;
repeatedly selecting groups of weights for a decision feedback equalizer;
using each selected group of weights to perform blind decision feedback equalization; and
for each selected group of weights, computing a metric indicating data reception quality; and
choosing a timing offset value and a group of weights based on the computed metrics.

2. The method of claim 1, wherein choosing the timing offset value and the group of weights based on the computed metrics comprises:
identifying which of the computed metrics has a best value; and
choosing the timing offset value and group of weights corresponding to the identified metric.

3. The method of claim 1, wherein:
computing the metric indicating data reception quality for each selected group of weights and each selected timing offset value comprises determining, for each selected group of weights and each selected timing offset value, a minimum distance between an output of the decision feedback equalizer and a decision threshold for the DFE; and
choosing the timing offset value and the group of weights based on the computed metrics comprises:
identifying a largest value of the minimum distances, and
choosing the timing offset value and the group of weights corresponding to the largest value.

4. The method of claim 1, wherein:
computing the metric indicating data reception quality for each selected group of weights and each selected timing offset value comprises determining a mean-squared error for the decision feedback equalizer for each selected group of weights and each selected timing offset value; and
choosing the timing offset value and the group of weights based on the computed metrics comprises:
identifying a smallest value of the mean-squared errors, and
choosing the timing offset value and the group of weights corresponding to the smallest value.

5. The method of claim 1, wherein:
computing the metric indicating data reception quality for each selected group of weights and each selected timing offset value comprises determining a signal-to-noise ratio for the decision feedback equalizer for each selected group of weights and each selected timing offset value; and
choosing the timing offset value and the group of weights based on the computed metrics comprises:
identifying a largest value of the signal-to-noise ratios, and
choosing the timing offset value and the group of weights corresponding to the largest value.

6. The method of claim 1, wherein choosing the timing offset value and the group of weights based on the computed metrics comprises:
identifying a respective computed metric that satisfies a predefined criterion; and
choosing the timing offset value and the group of weights corresponding to the respective computed metric.

7. The method of claim 6, further comprising ceasing repeatedly selecting timing offset values and groups of weights, in response to identifying the computed metric that satisfies the predefined criterion.

8. The method of claim 7, wherein identifying the respective computed metric that satisfies the predefined criterion comprises determining, for a selected group of weights and a selected timing offset value, that a minimum distance between an output of the decision feedback equalizer and a decision threshold exceeds a threshold.

9. The method of claim 7, wherein identifying the computed metric that satisfies the predefined criterion comprises determining, for a selected group of weights and a selected timing offset value, that a mean-squared error for the decision feedback equalizer is less than a threshold.

10. The method of claim 7, wherein identifying the computed metric that satisfies the predefined criterion comprises determining, for a selected group of weights and a selected timing offset value, that a signal-to-noise ratio for the decision feedback equalizer exceeds a threshold.

11. The method of claim 1, wherein:
repeatedly selecting timing offset values comprises successively selecting each timing offset value of a candidate set of timing offset values; and
repeatedly selecting groups of weights comprises successively selecting each group of weights of a candidate set of groups of weights.

12. The method of claim 1, further comprising:
using the chosen timing offset value as an initial timing offset for the timing recovery circuit during a normal mode of operation; and
using the chosen group of weights as a group of initial weights for the decision feedback equalizer during the normal mode of operation.

13. The method of claim 12, further comprising, in the normal mode of operation:
computing the metric indicating data reception quality;
determining that the metric does not satisfy a predefined criterion; and
in response to determining that the metric does not satisfy the predefined criterion, performing a search for an updated timing offset.

14. The method of claim 13, wherein the search is a bi-directional search centered on the initial timing offset.

15. A receiver, comprising:
an analog-to-digital converter (ADC) to sample a received signal;
a decision-feedback equalizer (DFE) to equalize the sampled signal;
a timing recovery circuit to provide a timing offset to the ADC; and
a controller to select between an initialization mode of operation and a normal mode of operation, wherein in the initialization mode the controller is to repeatedly select timing offset values for the timing recovery circuit in a first loop and to repeatedly select groups of weights for the DFE in a second loop nested within the first loop.

16. The receiver of claim 15, wherein, in the initialization mode:
the timing recovery circuit is to perform timing recovery using the selected timing offset values within the first loop;
the DFE is to perform blind decision feedback equalization using the selected groups of weights in the second loop and to compute a metric indicating data reception quality for each selected timing offset value and group of weights; and
the controller is to choose a timing offset value and a group of weights for the normal mode of operation based on the computed metrics.

17. The receiver of claim 16, wherein the metric indicating data reception quality comprises a minimum distance between an output of the DFE and a decision threshold for the DFE.

18. The receiver of claim 16, wherein the metric indicating data reception quality comprises a mean-squared error for the decision feedback equalizer.

19. The receiver of claim 16, wherein the metric indicating data reception quality comprises a signal-to-noise ratio for the decision feedback equalizer.

20. The receiver of claim 15, wherein:
the controller is to choose a timing offset value and a group of weights based on a determination that a corresponding computed metric satisfies a predefined criterion; and
the controller is to transition the receiver from the initialization mode to the normal mode in response to the determination that the corresponding computed metric satisfies the predefined criterion.

21. The receiver of claim 15, wherein:
the controller is to repeatedly select the timing offset values by successively selecting each timing offset value of a candidate set of timing offset values; and
the controller is to repeatedly select the groups of weights by successively selecting each group of weights of a candidate set of groups of weights.

22. A non-transitory computer-readable storage medium storing instructions that, when executed by a processor in a modem during an initialization mode, cause the modem to:
repeatedly select timing offset values for a timing recovery circuit;
for each selected timing offset value:
perform timing recovery using the timing offset value;
repeatedly select groups of weights for a decision feedback equalizer;
use each selected group of weights to perform blind decision feedback equalization; and
for each selected group of weights, compute a metric indicating data reception quality; and
choose a timing offset value and group of weights based on the computed metrics.

23. The computer-readable storage medium of claim 22, wherein the instructions to choose the timing offset value and the groups of weights based on the computed metrics comprise instructions to:
identify which of the computed metrics has a best value; and
choose the timing offset value and group of weights corresponding to the identified metric.

24. The computer-readable storage medium of claim 22, wherein:
the instructions to compute the metric indicating data reception quality comprise instructions to determine, for each selected group of weights and each selected timing offset value, a minimum distance between an output of the decision feedback equalizer and a decision threshold for the DFE; and
the instructions to choose the timing offset value and the group of weights based on the computed metrics comprise instructions to identify a largest value of the minimum distances and choose the timing offset value and the group of weights corresponding to the largest value.

25. The computer-readable storage medium of claim 22, wherein:
the instructions to compute the metric indicating data reception quality comprise instructions to determine a mean-squared error for the decision feedback equalizer for each selected group of weights and each selected timing offset value; and
the instructions to choose the timing offset value and the group of weights based on the computed metrics comprise instructions to identify a smallest value of the mean-squared errors and choose the timing offset value and the group of weights corresponding to the smallest value.

26. The computer-readable storage medium of claim 22, wherein:
the instructions to compute the metric indicating data reception quality comprise instructions to determine a signal-to-noise ratio for the decision feedback equalizer for each selected group of weights and each selected timing offset value; and
the instructions to choose the timing offset value and the group of weights based on the computed metrics comprise instructions to identify a largest value of the signal-to-noise ratios and choose the timing offset value and the group of weights corresponding to the largest value.

27. The computer-readable storage medium of claim 22, wherein the instructions to choose the timing offset value and the group of weights based on the computed metrics comprise:
instructions to identify a respective computed metric that satisfies a predefined criterion; and
instructions to choose the timing offset value and the group of weights corresponding to the respective computed metric.

28. The computer-readable storage medium of claim 27, further storing instructions that, when executed by the processor, cause the modem to cease repeatedly selecting timing offset values and groups of weights, in response to identifying the computed metric that satisfies the predefined criterion.

29. The computer-readable storage medium of claim 28, wherein the instructions to identify the respective computed metric that satisfies the predefined criterion comprise instructions to determine, for a selected group of weights and a selected timing offset value, that a minimum distance between an output of the decision feedback equalizer and a decision threshold exceeds a threshold.

30. The computer-readable storage medium of claim 28, wherein the instructions to identify the respective computed metric that satisfies the predefined criterion comprise instructions to determine, for a selected group of weights and a selected timing offset value, that a mean-squared error for the decision feedback equalizer is less than a threshold.

31. The computer-readable storage medium of claim 28, wherein the instructions to identify the respective computed metric that satisfies the predefined criterion comprise instructions to determine, for a selected group of weights and a selected timing offset value, that a signal-to-noise ratio for the decision feedback equalizer exceeds a threshold.

32. The computer-readable storage medium of claim 22, wherein:
the instructions to repeatedly select timing offset values comprise instructions to successively select each timing offset value of a candidate set of timing offset values; and
the instructions to repeatedly select groups of weights comprise instructions to successively selecting each group of weights of a candidate set of groups of weights.

33. The computer-readable storage medium of claim 22, further storing instructions that, when executed by the processor, cause the modem to:
use the chosen timing offset value as an initial timing offset for the timing recovery circuit during a normal mode of operation; and
use the chosen group of weights as a group of initial weights for the decision feedback equalizer during the normal mode of operation.

34. The computer-readable storage medium of claim 33, further storing instructions that, when executed by the processor in the normal mode of operation, cause the modem to:
compute the metric indicating data reception quality;
determine whether the metric does not satisfy a predefined criterion; and
perform a search for an updated timing offset, in response to determining that the metric does not satisfy the predefined criterion.

35. The computer-readable storage medium of claim 34, wherein the search is a bi-directional search centered on the initial timing offset.

36-42. (canceled)
